(19) United States
(12) Patent Application Publication
(10) Pub. No.: US 2014/0062285 A1
(43) Pub. Date: Mar. 6, 2014

(54) Method and Apparatus for a Large Area Inductive Plasma Source

(71) Applicant: Xing Chen, Lexington, MA (US)

(72) Inventor: Xing Chen, Lexington, MA (US)

(73) Assignee: MKS Instruments, Inc., Andover, MA (US)

(21) Appl. No.: 13/598,148

(22) Filed: Aug. 29, 2012

(51) Int. Cl. H05H 7/04; H05H 1/24

(52) U.S. Cl. CPC H05H 7/04; H05H 1/24
USPC 313/231.31; 315/111.41

(57) ABSTRACT

A plasma source for providing dissociated gas to semiconductor process chamber is provided. The plasma chamber can have at least one gas inlet and at least one chamber wall for containing the gas, a plurality of magnetic cores disposed relative to the plasma chamber such that the plasma chamber passes through each of the plurality of magnetic cores. A primary winding can be coupled to the plurality of magnetic cores. The plasma chamber can generate a toroidal plasma along a plane extending through the plasma chamber and which is at least substantially parallel to a top surface of a sample holder disposed within the semiconductor process chamber.

### FIELD OF THE INVENTION

This invention relates generally to the field of generating activated gas containing ions, free radicals, atoms, and molecules, and to apparatuses for and methods of processing materials with activated gas.

### BACKGROUND OF THE INVENTION

Plasma discharges can be used to excite gases to produce activated gases containing ions, free radicals, atoms and molecules. Activated gases are used for numerous industrial and scientific applications including processing solid materials such as semiconductor wafers, powders, and other gases. The parameters of the plasma and the conditions of the exposure of the plasma to the material being processed vary widely depending on the application.

For example, some applications require the use of ions with low kinetic energy (i.e. a few electron volts) because the material being processed is sensitive to damage. Other applications, such as ion implementation, anisotropic etching or planarized dielectric deposition, require the use of ions with high kinetic energies. Some other applications, such as reactive ion beam etching, require precise control of the ion energy. Still other applications, such as photoresist stripping, gate dielectric modification, and/or CVD chamber cleaning require reactive neutral species rather than ions based on, at least, higher chemical selectivity and lower surface damage that can be cause by neutral reactive species.

Plasmas can be generated in various ways including DC discharge, radio frequency (RF) discharge, and microwave discharge. DC discharges are achieved by applying a potential between two electrodes in a gas. RF discharges are achieved either by electrostatically or inductively coupling energy from a power supply into a plasma. Parallel plates are typically used for electrostatically coupling energy into a plasma. Induction coils are typically used for inducing current into a plasma. Microwave discharges are achieved by directly coupling microwave energy through a microwave-passing window into a discharge chamber containing a gas. Microwave discharges are advantageous because they can be used to support a wide range of discharge conditions, including highly ionized electron cyclotron resonant (ECR) plasmas.

Capacitively-coupled RF discharges and DC discharges inherently produce high energy ions and, therefore, are often used to generate plasmas for applications where the material being processed is in direct contact with the plasma. Microwave discharges produce dense, low ion energy plasmas. Microwave discharges are also useful for applications where it is desirable to generate ions at low energy and then accelerate the ions to the process surface with an applied potential.

RF inductively coupled plasmas are particularly useful for generating large area plasmas for such applications as semiconductor wafer processing. However, some RF inductively coupled plasmas are not purely inductive because the drive currents are only weakly coupled to the plasma. Consequently, RF inductively coupled plasmas are often inefficient and require the use of high voltages on the drive coils. The high voltages produce high electrostatic fields that cause high energy ion bombardment of reactor surfaces. The ion bombardment deteriorates the reactor and can contaminate the process chamber and the material being processed. The ion bombardment can also cause damage to the material being processed.

However, microwave and inductively coupled plasma sources require expensive and complex power delivery systems. These plasma sources require precision RF or microwave power generators and complex matching networks to match the impedance of the generator to the plasma source. In addition, precision instrumentation is usually required to ascertain and control the actual power reaching the plasma.

Current plasma source systems can provide a source of activated gas that uses a high efficiency RF power coupling device which couples power into a plasma without the use of conventional RF or microwave generators and impedance matching systems. Magnetic cores can be used to couple electromagnetic energy from a RF power supply to the plasma, which is generated in a loop which can be defined by a plasma chamber. Toroidal plasma sources have been used as remote plasma sources for generating activated gases to process materials located downstream from the plasma source.

In current toroidal plasma source, the plasma loop is oriented generally within a plane that is perpendicular to at least one of the process chamber lid or the substrate disposed within the process chamber. The process chamber is typically in communication with the plasma chamber through a single opening or port. For example, FIG. 1 of U.S. Pat. No. 6,150,628 shows a plasma chamber 20 having a single outlet into the process chamber 22 with a plasma loop 14 that is oriented generally within a plane that is perpendicular to a plane defined by a top surface of a substrate 23 disposed within the process chamber 22. This configuration can produce an insufficient level of plasma uniformity within the process chamber for certain applications (e.g., for semiconductor processes where the substrate to be processed is over a large area such as 300 mm or 450 mm wafers).

### SUMMARY OF THE INVENTION

One advantage of the invention is that ionized and/or activated gaseous species are substantially uniformly distributed within a process chamber, and can be distributed over a large area within the process chamber. Another advantage is that activated species generated by the plasma, such as ions, atoms, and excited molecules, can flow to the process chamber and substrate surfaces within a short time after they are produced, minimizing the losses of the activated species during transport. Minimizing losses of activated species during transport is important for gases with a short half-life (e.g., on the order of a millisecond or less). For example, atomic hydrogen, atomic chlorine, and atomic nitrogen each have a half-life that can be a millisecond or less.

Another advantage of the invention is that the distance between the plasma and the substrate to be processed within the semiconductor process chamber is substantially equal for each outlet from the toroidal plasma chamber into the semiconductor processing chamber, as the toroidal plasma is in parallel with the substrate surface. The lifetimes of the ions and various activated neutral species can be very different. The composition of the gaseous species therefore changes with the distance from plasma source. Orienting the plasma source in parallel with the substrate surface can result in the chemical compositions of the process gases being approximately uniform across the substrate surface.

In one aspect, the invention includes a plasma source for providing dissociated gas to semiconductor process chamber. The plasma source includes a plasma chamber having at least one gas inlet, at least one chamber wall for containing the gas, and at least one outlet into the semiconductor process chamber. The plasma source also includes a plurality of magnetic cores disposed relative to the plasma chamber such that the plasma chamber passes through each of the plurality of magnetic cores. The plasma chamber generates a toroidal plasma along a plane extending through the plasma chamber and which is at least substantially parallel to a top surface of a sample holder disposed within the semiconductor process chamber. The plasma source also includes a primary winding coupled to the plurality of magnetic cores.

In some embodiments, the plasma source includes an RF power supply, the RF power supply having an output coupled to the primary winding to drive current in the primary winding, the current induces an AC potential within the plasma chamber. In some embodiments the plasma source includes a showerhead located between the plasma chamber and the sample holder to distribute excited gas output from the plasma chamber over a substrate positioned atop the sample holder.

In some embodiments, the plasma source includes at least one electrode capacitively coupled to the plasma chamber to generate free charges that assist the ignition of a plasma in the plasma chamber.

In another aspect, the invention involves a method for dissociating gas within a plasma source for use in a semiconductor process chamber. The method involves flowing via at least one inlet, a gas into a toroidal plasma chamber having a primary winding coupled to the toroidal plasma chamber and a plurality of magnetic cores oriented such that the toroidal plasma chamber passes through each of the plurality of magnetic cores. The method also involves generating a plasma along a plane extending through the toroidal plasma chamber, such plasma being at least substantially parallel to a top surface of a sample holder disposed within the semiconductor process chamber. The method also involves directing the plasma, via at least one outlet in the toroidal plasma chamber, in an orthogonal direction relative to the plane toward the top surface of the sample holder.

In some embodiments, the method involves coupling the toroidal plasma chamber to a top of the semiconductor process chamber. In some embodiments, the method involves positioning the at least one outlet in a substantially central location in the process chamber top.

In some embodiments, the method involves evenly distributing the plurality of magnetic cores around a circumference of the toroidal plasma chamber. In some embodiments, the method involves positioning a showerhead between the plasma source and the sample holder to distribute excited gas output from the plasma chamber over a substrate positioned atop the sample holder.

In some embodiments, the method involves flowing via a second gas inlet, the gas into a second toroidal plasma chamber having a second primary winding coupled to the second toroidal plasma chamber and a second plurality of magnetic cores oriented such that the second toroidal plasma chamber passes through each of the second plurality of magnetic cores, generating a second plasma along a plane extending through the second toroidal plasma chamber, such second plasma being at least substantially parallel to a surface of the sample holder disposed within the semiconductor process chamber, and directing the second plasma, via a second outlet in the toroidal plasma chamber, in a direction orthogonal to the plane toward the surface of the sample holder.

In another aspect, the invention includes a plasma source. The plasma source includes a toroidal plasma chamber, a primary winding around an exterior of the toroidal plasma chamber, and a plurality of magnetic cores, wherein the ring plasma chamber passes through each of the plurality of magnetic cores.

In some embodiments, the toroidal plasma chamber is coupled to a process chamber top and further comprising a plurality of outlets into the process chamber top. In some embodiments, at least one of the plurality of outlets is located in a substantially central location in the process chamber top.

In some embodiments, the toroidal plasma chamber includes at least one process gas inlet coupling a process gas source to the plasma chamber. In some embodiments, the magnetic cores are substantially evenly distributed around the circumference of the toroidal plasma chamber. In some embodiments, the ferrites are in a plurality of groups around the circumference of the toroidal plasma chamber.

In some embodiments, the toroidal plasma chamber is coupled to a process chamber such that a toriodal plasma generated in the toroidal plasma chamber is at least substantially parallel to a top surface of a sample holder disposed within the process chamber.

In another aspect, the invention includes a plasma source. The plasma source includes a plurality of toroidal plasma chambers, a plurality of primary windings, wherein each one of the plurality of primary windings is wrapped around an exterior one of the plurality of the toroidal plasma chambers, and a plurality of magnetic cores, wherein each one of the plurality of the toroidal plasma chamber passes through a respective portion of the plurality of magnetic cores.

In some embodiments, the plurality of toroidal plasma chambers are substantially concentric. In some embodiments, each one of the plurality of toroidal plasma chambers are adjacent to at least another one of the plurality of toroidal plasma chambers. In some embodiments, each one of the plurality of plasma chambers includes corresponding plurality of plasma chamber outlets coupling each one of the plurality the plasma chambers to a process chamber.

In some embodiments, at least one process gas inlet to couple a process gas source to each one of the plurality the plasma chambers. In some embodiments, the magnetic cores are substantially evenly distributed around the circumference of the ring plasma chamber. In some embodiments, the magnetic cores are in a plurality of groups each group is located around the circumference of one of the plurality of ring plasma chambers.

In some embodiments, the toroidal plasma chamber is one of a group of shapes consisting of substantially round, substantially triangular, substantially rectangular, or substantially polygonal shape. In some embodiments, each of the plurality of toroidal plasma chambers is coupled to a process chamber such that a plasma generated in each of the plurality of toroidal plasma chambers is substantially parallel to a substrate within the process chamber.

In another aspect, the invention includes a plasma source. The plasma source includes a toroidal plasma chamber and a primary winding around an exterior of the toroidal plasma chamber. The plasma source also includes a plurality of magnetic cores, wherein the toroidal plasma chamber passes through each of the plurality of magnetic cores. The plurality of magnetic cores also includes a plurality of plasma chamber outlets coupling the toroidal plasma chamber to a process chamber, each one of the plurality plasma chamber outlets having a respective plasma restriction.

In some embodiments, at least one process gas inlet couples a process gas source to the plasma chamber. In some embodiments, the plasma source includes a process gas flow rate control device coupled to the at least one process gas inlet. In some embodiments, the magnetic cores are substantially evenly distributed around the circumference of the ring plasma chamber. In some embodiments, the magnetic cores are in a plurality of groups, each group is located around the circumference of the toroidal plasma chamber.

In some embodiments, the toroidal plasma chamber is one of a group of shapes consisting of substantially round, substantially triangular, substantially rectangular, or substantially polygonal shape. In some embodiments, the toroidal plasma chamber is coupled to a process chamber such that a plasma generated in the toroidal plasma chamber is substantially parallel to a substrate within the process chamber.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic representation of a plasma source for producing activated gases, according to an illustrative embodiment of the invention.

FIG. 1A is a schematic representation of a plurality of magnetic cores coupled to a primary coil, according to an illustrative embodiment of the invention.

FIG. 1B is a schematic representation of a plurality of magnetic cores coupled to a primary coil, according to an illustrative embodiment of the invention.

FIG. 1C is a schematic representation of a plurality of magnetic cores coupled to a plurality of primary coils, according to an illustrative embodiment of the invention.

FIG. 2 is a three-dimensional schematic representation of a plasma source coupled to a process chamber lid, according to an illustrative embodiment of the invention.

FIG. 3 is a schematic cross-sectional representation of a plasma source coupled to a process chamber lid, according to an illustrative embodiment of the invention.

FIG. 4 is a plan view representation of plasma source coupled to a process chamber lid, according to an illustrative embodiment of the invention.

FIG. 5A is a three dimensional cross sectional view of a semiconductor processing chamber lid that includes a plasma source, according to an illustrative embodiment of the invention.

FIG. 5B is a two dimensional cross section view of the semiconductor process chamber lid shown in FIG. 5A, according to an illustrative embodiment of the invention.

### DETAILED DESCRIPTION

The present invention features a plasma source for use during semiconductor processing. The plasma source includes one or more toroidal plasma chambers. Each toroidal plasma chamber is configured to contain a plasma loop formed within such chamber. The one or more toroidal plasma chambers are coupled to a process chamber such that each plasma loop is oriented substantially parallel to a substrate holder disposed within the process chamber. A plasma loop having a parallel orientation relative to the substrate holder allows a larger area of a substrate to be processed by the activated gases and provides a more even distribution of the activated gases on the surface of the substrate to be processed.

Some embodiments of the invention feature a plasma source that is coupled to a lid of a semiconductor process chamber. The plasma source can include multiple magnetic cores and a toroidal plasma chamber that passes through the multiple magnetic cores. The plasma source can be coupled to (i.e., built onto or into) the top of the semiconductor process chamber such that a plasma can be generated within the toroidal plasma chamber in close proximity to a substrate holder located within the process chamber. The process chamber includes a base, a lid, and walls. The toroidal plasma chamber and the substrate holder can be approximately parallel with each other, and oriented orthogonally relative to the semiconductor process chamber walls. The toroidal plasma chamber includes a plurality of outlets for providing a plurality of flow paths into the semiconductor process chamber. The plurality of outlets allow a gaseous species that has been ionized or activated by the plasma in the toroidal plasma chamber to flow into the process chamber with high uniformity and less loss in comparison to a toroidal plasma chamber with a single outlet. An optional showerhead further helps to deliver the gas uniformly over a substrate.

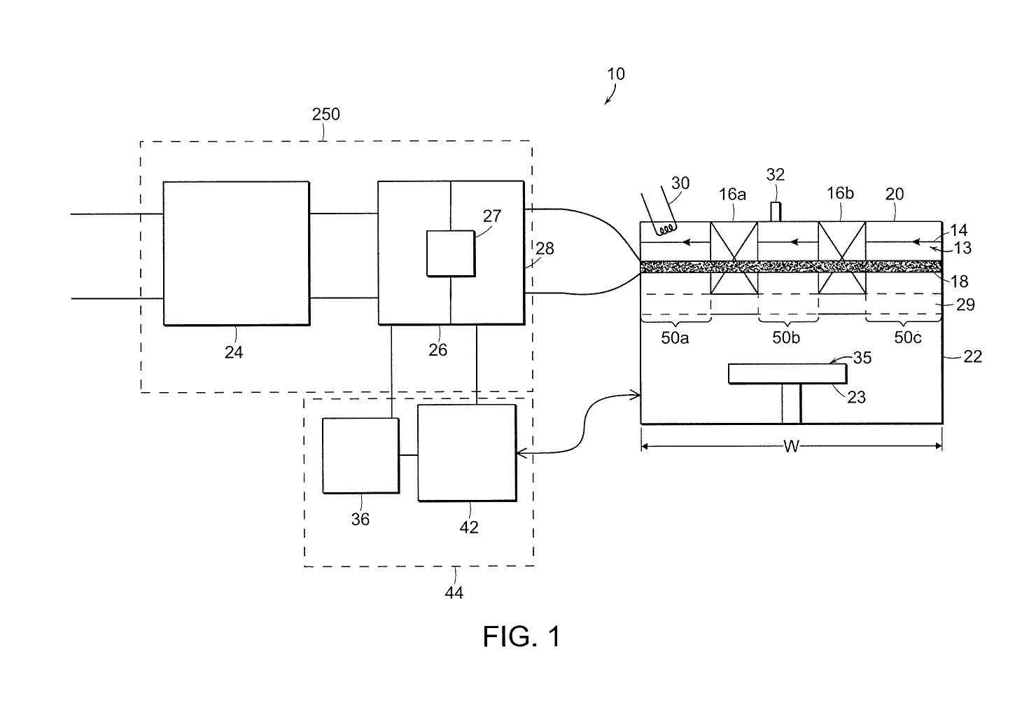

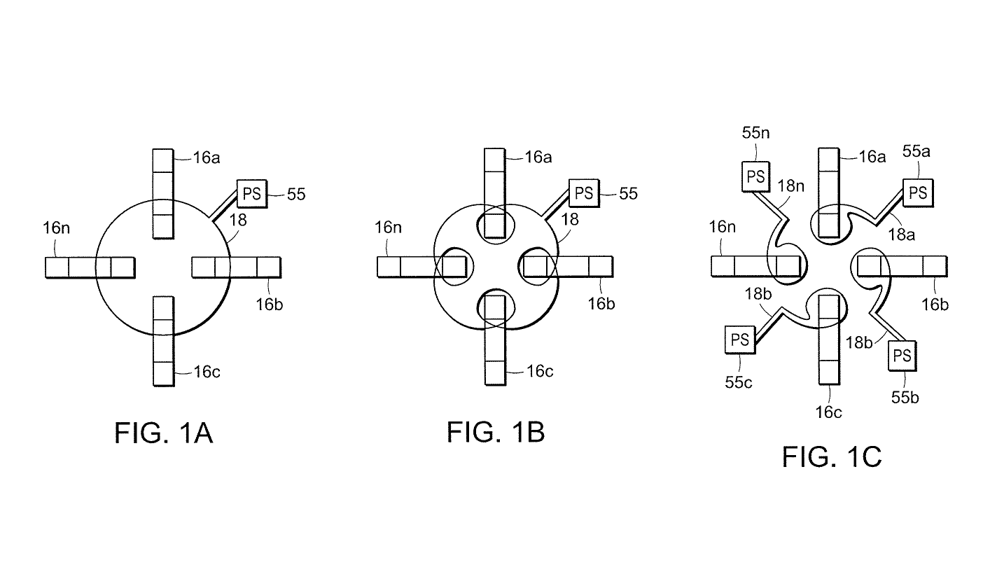

FIG. 1 is a schematic representation of a plasma source 10 for producing activated gases, according to an illustrative embodiment of the invention. The plasma source provides activated gases to a semiconductor process chamber 22. The plasma source 10 includes a power transformer, a plasma chamber 20, a plasma ignition electrode 30, a switching power supply 250, and a feedback loop 44.

The power transformer includes a plurality of magnetic cores, 16a, and 16b, generally 16, a primary coil 18, and the plasma 14. The power transformer couples power received from the switching power supply 250 into the plasma 14. Each of the plurality of magnetic cores 16 wrap around the plasma chamber 20 such that the plasma chamber 20 passes through each of the plurality of magnetic cores 16. As shown, the primary coil 18 is wrapped around a circumference of an exterior surface 15 of the plasma chamber 20 and each of the plurality of magnetic cores 16. The primary coil 18 and the plurality of magnetic cores 16 allow the plasma 14 formed within the plasma chamber 20 to form a secondary circuit of the power transformer. In various embodiments, the power transformer includes two, four or any number of magnetic cores.

In various embodiments, the plasma chamber 20 can be made of a dielectric material, such as quartz, alumina or sapphire, or a metal such as aluminum, or a coated metal such as anodized aluminum. When a metallic material is used to form the plasma chamber, at least one dielectric gap in the plasma chamber can be provided to prevent electric current from flowing along the plasma chamber walls. The dielectric gap can include a dielectric spacer and a vacuum seal, and can contain features for protecting the vacuum seal from damage by the plasma and/or UV radiation from the plasma, as shown, for example, in FIG. 4 of U.S. Pat. No. 6,150,628, which is incorporated herein by reference in its entirety. Multiple dielectric gaps can be used to improve the uniformity of induced electric field along a toroidal plasma chamber in order to reduce ion damage to the chamber surface.

The primary coil 18 can be coupled to plasma chamber 20 and the plurality of magnetic cores 16 in various configurations so that power can be supplied to the plurality of magnetic cores 16 to induce an electromagnetic field. FIG. 1A shows an illustrative embodiment in which the primary coil 18 is coupled to a power source 55 and the plurality of magnetic cores 16. More specifically, the plurality of magnetic cores 16 are coupled to the primary coil 18 by looping the primary coil 18 around the plurality of magnetic cores 16 in a single loop configuration. FIG. 1B shows an illustrative embodiment in which the primary coil 18 is coupled to the power source 55 and the plurality of magnetic cores 16. Specifically, the plurality of magnetic cores 16 are coupled to the primary coil 18 by looping the primary coil 18 around each of the plurality of magnetic cores 16 individually. FIG. 1C shows an illustrative embodiment in which each of the plurality of magnetic cores 16 is coupled to its own power source and corresponding separate primary coil. In particular, magnetic core 16a is powered by power supply 55a and primary coil 18a, magnetic core 16b is powered by power supply 55b and primary coil 18b, magnetic core 16c is powered by power supply 55c and primary coil 18c, and magnetic core 16n is powered by power supply 55n and primary coil 18n.

In some embodiments, the primary coil 18 is wrapped around a circumference of an exterior surface 15 of the plasma chamber 20 and inside of each of the plurality of magnetic cores 16. In some embodiments, the primary coil 18 is replaced by a plurality of coils. In these embodiments, each of the plurality of magnetic cores 16 has corresponding coil spaced therefrom.

In some embodiments, the primary coil 18 can be wound around the exterior of the plasma chamber 20 as shown, for example, in FIG. 4A of U.S. Pat. No. 7,969,096, which is incorporated herein by reference in its entirety. In another example, the R*evolution remote plasma product manufactured by MKS Instruments, Inc. of Andover, Mass., includes a primary coil wound around the exterior of a toroidal plasma chamber (e.g., in parallel with the toroidal plasma chamber).

In some embodiments, each of the plurality of magnetic cores 16 is a high permeability ferrite. In some embodiments, each of the plurality of magnetic cores 16 is a ferrite. A high permeability magnetic core can reduce leakage of magnetic flux, therefore improving coupling efficiency and reducing primary current and voltage required from the power supply. In some embodiments, the toroidal plasma source operates with a frequency range of 50 kHz to 100 MHz.

Referring back to FIG. 1, during operation, the plasma 14 activates gases that enter the plasma chamber 20 via gas inlet 32 to form ions, free radicals, atoms and molecules. The activated gases exit the plasma chamber 20 and enter the process chamber 22 via outlets 50a, 50b, 50n, generally 50, of the plasma chamber 20. The plasma chamber 20 includes at least one wall. In some embodiments, the plasma chamber 20 includes multiple gas inlets. In various embodiments, the plasma chamber 20 has one gas outlet for each magnetic core. In various embodiments, the plasma chamber 20 includes more gas outlets than magnetic cores. In various embodiments, the gas inlets and outlets are arranged such that gas-plasma interaction times are approximately equal for all inlet gases.

In some embodiments, the process chamber lid 29 includes holes to receive the plasma chamber outlets 50. In some embodiments, the process chamber lid 29 and the plasma chamber 20 are coupled together by elasmer vacuum seals. In some embodiments, the process chamber lid 29 and the plasma chamber 20 are coupled together by a metallic bond.

A sample holder 23 may be positioned in the process chamber 22 to support the material to be processed. The material to be processed may be biased relative to the potential of the plasma. During operation, the plasma 14 generally forms a loop in a plane that is substantially parallel to a top surface 35 of the sample holder 23. In some embodiments, a showerhead (not shown) is located between the plasma chamber outlets 50 and the sample holder 23, such that the activated gas is distributed substantially uniformly over the surface of the material to be processed.

The switching power supply 250 includes a voltage supply 24, which can be a line voltage supply or a bus voltage supply, which is directly coupled to a switching circuit 26 containing one or more switching semiconductor devices. The one or more switching semiconductor devices may be switching transistors. The circuit may be a solid state switching power supply. An output 28 of the switching circuit 26 may be directly coupled to the primary winding 18 of the transformer 12.

The switching power supply 250 can be a solid state switching supply, as described in, for example, FIG. 7 and FIG. 8 of U.S. Pat. No. 6,388,226, which is incorporated herein by reference in its entirety.

The plasma source 10 may include an apparatus for generating free charges that provides an initial ionization event that ignites a plasma in the plasma chamber 20 as described herein. A noble gas, such as argon, may also be inserted into the plasma chamber 20 to reduce the voltage required to ignite a plasma. Free charges can be generated in numerous ways as described herein. For example, free charges can be generated by applying a short high voltage pulse to an electrode inside of the plasma chamber 20. Also, free charges can be generated by applying a short high voltage pulse directly to the primary coil 18. In another embodiment, a high electric voltage signal may be applied to an electrode, located outside of a dielectric plasma chamber 20 but capacitively coupled to the plasma volume, to generate free charges to assist ignition in the plasma chamber 20.

In another embodiment, an ultraviolet light source (not shown) is used to generate free charges that provide an initial ionization event, which ignites a plasma in the plasma chamber 20. The ultraviolet (UV) light source can be optically coupled to the plasma chamber 20. The UV light source can be optically coupled to the plasma channel through an optically transparent window. The UV light source can either be a continuous wave (CW) light source or a pulsed light source depending on the duty cycle of the plasma source.

In some embodiments, the plasma chamber can be cooled as described, for example, in U.S. Pat. No. 6,872,909 which is incorporated herein by reference in its entirety.

The plasma source 10 can also include a measuring circuit 36 for measuring electrical parameters of the primary winding 18. Electrical parameters of the primary winding 18 include the current driving the primary winding 18, the voltage across the primary winding 18, the bus or line voltage that is generated by the voltage supply 24, the average power in the primary winding 18, and the peak power in the primary winding 18. The electric parameters of the primary winding may be continuously monitored.

The plasma source 10 can also include an apparatus for measuring electrical and optical parameters of the plasma 14 itself. For example, the source 10 may include a current probe (not shown) that is positioned around the plasma chamber 20 to measure the plasma current flowing in the plasma secondary. Also, the voltage on the plasma secondary can be measured, for example, by positioning a secondary winding on the magnetic core parallel to the plasma 14. The electric power applied to the plasma can be determined from measurements of the AC line voltage and current and from known losses in the electric circuit.

The plasma source 10 can also include an optical detector for measuring the optical emission from the plasma 14. The electric and optical parameters of the plasma 14 can be continuously monitored. In addition, the plasma source 10 can include a power control circuit 42 that accepts data from at least one of the current probe, the power detector, and the switching circuit 26 and then adjusts the power in the plasma by adjusting the current in the primary winding 18.

In operation, a gas is bled into the plasma chamber 20 until a pressure that is between about 0.1 mTorr and about 1,000 Torr is reached. The gas can comprise a noble gas, a reactive gas or a mixture of at least one noble gas and at least one reactive gas. The switching circuit 26 containing switching semiconductor devices that supply a current to the primary winding 18 that induces a potential inside the plasma chamber 20.

The magnitude of the induced potential depends on the magnetic field produced by the plurality of magnetic cores 16 and the frequency at which the switching semiconductor devices operate according to Faraday's law of induction. An ionization event that forms the plasma may be initiated in the chamber 20. The ionization event may be the application of a voltage pulse to the primary winding or to the electrode 30 positioned in the chamber 20 as described herein. Alternatively, the ionization event may be exposing the inside of the plasma chamber 20 to ultraviolet radiation.

Once the gas is ionized, a plasma is formed in the plasma chamber 20 that completes a secondary circuit of the power transformer. The shape of the plasma 14 can be determined based, in part, on the shape of the plasma chamber 20. The toroidal plasma chamber 20 can vary from circular to non-circular (loop, circle, ring, oval, rectangle etc.). In some embodiments, the diameter of a circular plasma loop can be from approximately 2.0 to 20.0 inches. The diameter of the cross-section of the plasma loop can be from 0.5 to 2 inches depending upon the process requirements. Changing the diameter of the plasma loop or the size of the cross-section of the plasma loop can change the gas flow dynamics and the plasma impedance and can allow the plasma source to be optimized for different operating ranges (i.e. different substrate sized, power levels, pressures ranges, gases, and gas flow rates).

Changing the shape of a non-circular plasma loop or the cross-section of the plasma loop can allow the flow patterns for neutral species and flow patterns of the plasma itself to be separately optimized for different operating regimes. The process gas injected from gas inlet(s) 32 can flow both along and across the plasma loop to the gas outlets 50a, 50b and 50c. The shape of the cross-section of the plasma loop can be circular, oval, rectangular, or “D” shaped. In one embodiment, the ratio of the maximum to the minimum dimension may vary from about 1 (i.e. a circular cross section) to 10 depending upon the particular application.

The electric field of the plasma may be substantially between about 1-200 V/cm. If only noble gases are present in the plasma chamber 20, the electric fields in the plasma 14 may be as low as 1 volt/cm. If, however, electronegative gases are present in the plasma chamber 20, then the electric fields in the plasma 14 can be considerably higher. In some embodiments, operating the plasma source 10 with low electric fields in the plasma 14 is desirable because a low potential difference between the plasma 14 and the chamber 20 will substantially reduce erosion of the chamber 20 caused by energetic ions. This will substantially reduce the resulting contamination to the material being processed. Reducing erosion of the chamber 20 is not required in some embodiments.

The power delivered to the plasma can be accurately controlled by a feedback loop 44 that comprises the power control circuit 42, the measuring circuit 36 for measuring electrical parameters of the primary winding 18 and the switching circuit 26 containing one or more switching semiconductor devices. In addition, the feedback loop 44 may include a voltage probe and a current probe.

In some embodiments, the power control circuit 42 measures the power in the plasma using the measuring circuit 36 for measuring electrical parameters of the primary winding 18. The power control circuit 42 compares the resulting measurement to a predetermined value representing a desired operating condition and then adjusts one or more parameters of the switching circuit 26 to control the power delivered to the plasma. The one or more parameters of switching circuit 26 include, for example, voltage and current amplitude, frequency, pulse width, and relative phase of the drive pulses to the one or more switching semiconductor devices.

In some embodiments, the power control circuit 42 measures the power in the plasma using a voltage probe and a current probe. The power control circuit 42 then compares the measurement to a predetermined value representing a desired operating condition and then adjusts one or more parameters of the switching circuit 26 to control the power delivered to the plasma.

In one embodiment, the plasma source 10 may include protection circuits to ensure that the plasma source 10 is not damaged either through abnormal environmental conditions or through abnormal usage. The temperature of the plasma source 10 may be monitored at numerous locations to ensure that an appropriate amount of cooling fluid is flowing and that an abnormally high amount of power is not being dissipated in the source. For example, the temperature of the mounting blocks for the switching devices, the plasma chamber 20 itself, and the magnetic core may be monitored. Also, the current flowing though the FET devices may be monitored. If the current exceeds predetermined values the plasma source 10 may be shut down, thereby protecting the switching devices against possible damage.

The plasma source 10 is useful for processing numerous materials, such as solid surfaces, powders, and gases. The plasma source 10 is particularly useful for providing activated gases in semiconductor processing equipment, such as thin film deposition and etching systems. The plasma source 10 is also particularly useful for photoresist stripping, atomic layer deposition, wafer cleaning, and gate oxide or dielectric modification.

The plasma source can be used to etch numerous materials, such as silicon, silicon dioxide, silicon nitride, aluminum, molybdenum, tungsten and organic materials like photoresists, polyimades and other polymeric materials. The plasma source 10 can be used for plasma enhanced deposition of numerous thin films materials, such as diamond films, silicon dioxide, silicon nitride, and aluminum nitride.

In addition, the plasma source 10 can be used to generate reactive gases, such as atomic fluorine, atomic chlorine, atomic hydrogen, atomic bromine, atomic nitrogen, and atomic oxygen. Such reactive gases are useful for reducing, converting, stabilizing or passivating various oxides, such as silicon dioxide, tin oxide, zinc oxide and indium-tin oxide. Specific applications include fluxless soldering, removal of silicon dioxide from a silicon surface, passivation of silicon surfaces prior to wafer processing, and surface cleaning of various metal and dielectric materials such as copper, silicon, and silicon oxides.

Other applications of the plasma source 10 include modification of surface properties of polymers, metals, ceramics and papers. In addition, the plasma source 10 may be used to generate high fluxes of atomic oxygen, atomic chlorine, or atomic fluorine for sterilization.

In various embodiments, the surface material of the plasma chamber is selected based on applications and/or gas chemistries to be used during a particular process. For example, quartz is relatively stable to oxygen and chlorine plasmas, but it can be etched in fluorine and hydrogen plasmas. For generating plasmas containing fluorine, the surface of the plasma chamber can be made of aluminum, magnesium, yttrium, or their compounds because these elements can have stable fluorides.

In various embodiments, the composition of the process gases can be tailored to minimize erosion of the plasma chamber surface. For example, surfaces containing aluminum oxide, such as sapphire, alumina, or anodized aluminum, can be eroded by a hydrogen plasma. Hydrogen ions first reduce aluminum oxide and subsequently convert it to volatile aluminum hydride. Addition of a small amount of oxygen in hydrogen, in the form of O₂ or H₂O and in the range of 1-1000 ppm, can stabilize the aluminum oxide surface and substantially reduce its erosion

The plasma current and plasma current density of the plasma 14 generated by the plasma source 10 may be selected to optimize dissociation of particularly gases for particular applications. For example, the plasma current and plasma current density can be selected to optimize NF3 dissociation. NF3 is widely used as a source of fluorine for chamber cleaning and numerous other applications. NF3 is relatively expensive. Optimizing the plasma source 10 for high NF3 dissociation rates improves the gas utilization rate and reduces the overall cost of operating the system. In addition, increasing the dissociation rate of NF3 is desirable because it reduces the release of environmentally hazardous gases into the atmosphere.

The dissociation of NF3 is caused by collisions between the NF3 molecules and the electrons and hot gases in the plasma. The density of electrons in the plasma source is approximately proportional to the plasma current density. There exists an optimal range of plasma current densities that maximize the dissociating of NF3 molecules. In one embodiment, a toroidal plasma 14 having a length of approximately 40-60 cm, the optimal plasma current density for efficiently dissociating NF3 gas is between 5-20 A/cm². In one embodiment, a toroidal plasma 14 having a cross sectional area of 3-10 cm², this current density range corresponds to a total toroidal plasma current in the range of approximately 20-200 A.

The materials used in the internal surface of the plasma chamber 20 and the elements that connect the output of the plasma chamber 20 to the process chamber 22 must be carefully chosen, especially if the plasma source will be used to generate chemically reactive species. Materials are selected to meet several requirements. One requirement of the materials is that the creation of contamination that results from corrosion or deterioration of the material caused by interaction of the materials with the process gases should be minimized. Another requirement of the materials is that they have minimal erosion when exposed to process gases. Another requirement of the materials is that they should minimize recombination and deactivation of the reactive gas, thus maximizing reactant delivery to the process chamber.

Anodized aluminum has some advantages for semiconductor processing applications. One advantage is that anodized aluminum can be grown directly on an underlying aluminum base through an electrolytic process. The resulting film has excellent adherence properties. Another advantage is that anodized aluminum has a thermal conductivity that is approximately 15 times greater than the thermal conductivity of quartz. Therefore, the inside surface of plasma chambers that are formed with anodized aluminum will remain relatively cool, even with significant incident power density.

Another advantage is that anodized aluminum is chemically inert to many atomic species (F, O, Cl, etc.) as long as there is no or only low-energy ion bombardment present. Anodized aluminum is particularly advantageous for fluorine chemistries because it has a low recombination coefficient for atomic fluorine. Also, anodized aluminum is a material that is commonly used and accepted for semiconductor materials processing applications.

Quartz also has some advantages for semiconductor processing applications. Quartz is available in extremely high purity and is commonly used and accepted in the semiconductor industry. Also, quartz is stable with numerous reactive species including O, H, N, Cl, and Br. In particular, quartz has a low surface recombination coefficient for atomic oxygen and hydrogen. Also, quartz has a low thermal coefficient of expansion and has relatively high resistance to thermal shock. In addition, quartz has a high softening and melting point and, therefore, it is relatively easy to form a process chamber from quartz.

Fluoropolymers also have some advantages for semiconductor processing applications. Examples of some fluoropolymers are PTFE, PFE, PFA, FEP, and Teflon™. The recombination rate for many fluoropolymers is relatively low. Fluoropolymers also are relatively inert to most atomic species including atomic fluorine and atomic oxygen. In addition, the purity of fluoropolymers is relatively high and fluoropolymers are available in both bulk form (tube, sheet, etc.) and in thin film form.

In some embodiments, fluoropolymers, however, can be eroded by ions in the plasma. Also, the maximum operating temperature that fluoropolymers can tolerate is significantly less than the maximum temperature that quartz can tolerate. In addition, the thermal conductivity of fluoropolymers is relatively low. Therefore, in some embodiments, fluoropolymers are most useful for constructing the transport sections outside of the plasma chamber.

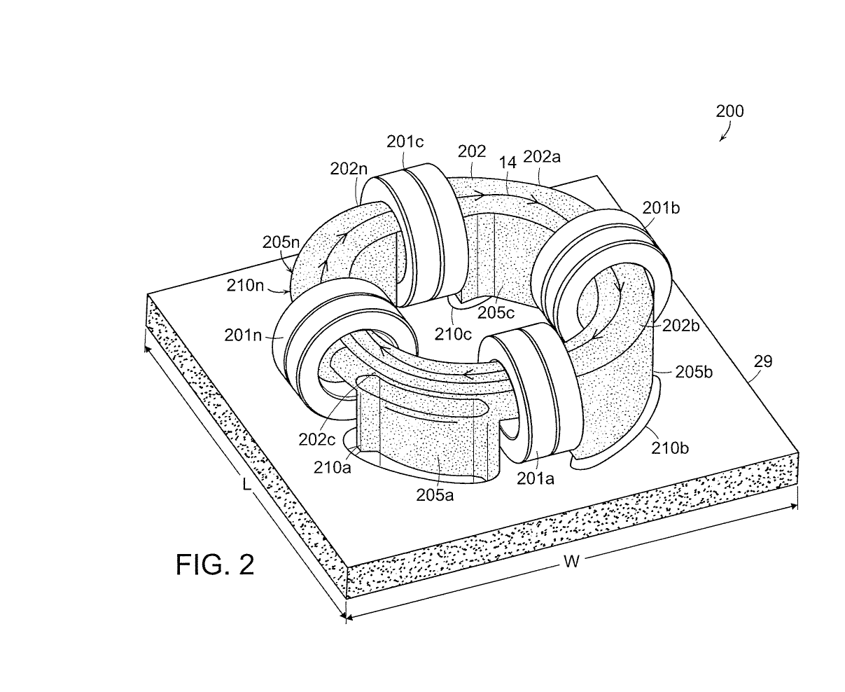

FIG. 2 is a three-dimensional schematic representation of a plasma source 200 coupled to a process chamber lid 29, according to an illustrative embodiment of the invention.

The plasma source 200 includes a toroidal plasma chamber 202, a plurality of circular shaped magnetic cores, 201a, 201b, 201c, . . . 201n, generally 201, and a power source as, for example, described above in FIG. 1 (not shown). The toroidal plasma chamber 20 is surrounded by the plurality of circular shaped magnetic cores 201. The toroidal plasma chamber 20 includes a plurality of outlets 205a, 205b, 205c, . . . 205n, generally 205, to allow gases that are activated by a plasma 14 generated within the torodial plasma chamber 202 to exit the toroidal plasma chamber 20 through the process chamber lid 29 into a process chamber (not shown). The process chamber lid 29 has a plurality of holes, 210a, 210b, 210c, . . . 210n, generally 210, such that there is corresponding process chamber lid hole 210 for each toroidal plasma outlet 205.

During operation, the plasma 14 that flows within the toroidal plasma chamber 202 flows substantially within a loop (e.g., circle or oval) on a first plane that is substantially parallel to a second plane that extends from a top surface of a sample holder within a semiconductor process chamber (e.g., sample holder 23 as shown above in FIG. 1). In some embodiments, the second plane is defined as a plane that extends along a width W and the length L of the process chamber lid 29.

The toroidal plasma chamber 202 can be formed from a metal such as aluminum, copper, nickel and steel. In some embodiments, the toroidal plasma chamber 202 is formed from a coated metal such as anodized aluminum or nickel plated aluminum. In some embodiments, the toroidal plasma chamber 202 is formed from a dielectric material such as quartz, sapphire, or alumina. In some embodiments, the toroidal plasma chamber 202 includes imbedded cooling channels for passing a fluid that controls the temperature of toroidal plasma chamber 202.

When a metallic material is used to form the plasma chamber 202, the plasma chamber 202 can be include multiple sections with dielectric gaps in between the sections to prevent induced electric current from flowing along the plasma chamber walls. In the example illustrated in FIG. 2, the plasma chamber 202 includes multiple sections, for example, a first section 202a, a second section, 202b, a third section 202c, and a fourth section 202n.

The multiple sections, 202a, 202b, 202c, and 202n, can be joined together with dielectric gaps between each section. The dielectric gaps can be positioned under the magnetic cores 201a, 201b, 201c and 201n. The plasma chamber sections can be mounted onto the chamber lid 29 between the magnetic cores without additional electric isolation. Each dielectric gap can include a dielectric spacer and a vacuum seal, and can contain features for protecting the vacuum seal from damage by the plasma and/or UV radiation from the plasma.

In various embodiments, the magnetic cores 201 are squares, triangles, ellipses, parallelograms, or any shape that can be wrapped around a portion of the toroidal chamber, and combination thereof. In various embodiments, the magnetic cores are partially or fully embedded in the process chamber lid 29.

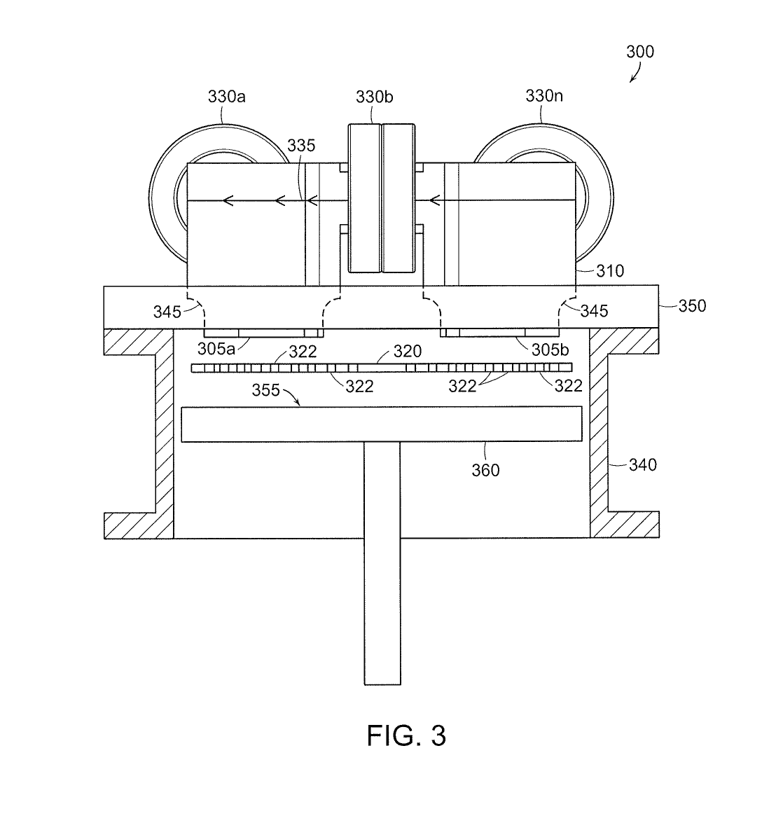

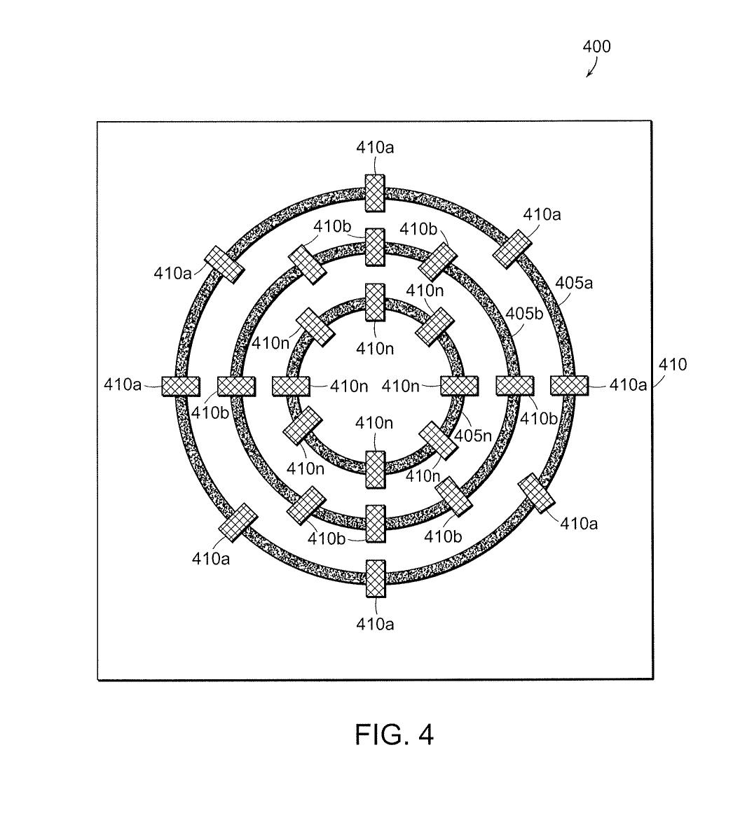

FIG. 3 is a schematic cross-sectional representation of the plasma source 300 coupled to a process chamber lid 350, according to an illustrative embodiment of the invention. The plasma source 300 includes a toroidal plasma chamber 310, a plurality of circular shaped magnetic cores, 330a, 330b, . . . 330n, generally 330, and a power source as, for example, described above with reference to FIG. 1 (not shown here). The toroidal plasma chamber 310 is surrounded by the plurality of circular shaped magnetic cores 330. The toroidal plasma chamber 310 includes a plurality of outlets 305a, 305b, generally 305, to allow gases that are activated by a plasma 335 generated within the torodial plasma chamber 310 to exit the toroidal plasma chamber 310 through the process chamber lid 350 into a process chamber 340. The process chamber lid 350 has a plurality of holes 345 such that there is corresponding process chamber lid hole 345 for each toroidal plasma outlet 305.

During operation, the plasma 335 that flows within the toroidal plasma chamber 310 flows within a loop (e.g., ring-shaped, circular or oval) configuration oriented in a first plane that is substantially parallel to a second plane formed by a top surface 355 of a sample holder 360 within a semiconductor process chamber 340. In some embodiments, the second plane can be defined by a surface of the process chamber lid 350.

The plasma 335 generates an activated gas that flows into the process chamber 340 via the plurality outlets 305. In various embodiments, the number of outlets 305 is two, five, ten or any number. In some embodiments, the number of outlets 305 is based on physical characteristics of the substrate to be processed. For example, for a 300 mm substrate, the plasma chamber can include four arch-shaped outlets, each with a 1-inch by 6-inch opening. The plurality of outlets 305 can create a substantially even distribution of activated gas entering the process chamber 340.

In some embodiments, the process chamber 340 includes a member for uniform distribution of the activated gases to the substrate. For example, the process chamber 340 can include a shower head member. The showerhead member 320 includes a plurality of holes 322 that allow the activated gases that flow out of the plasma chamber 310 into the process chamber 340 to be even further distributed prior to interacting with a substrate that is on the sample holder 360. In some embodiments, the showerhead blocks UV light emitted from the plasma from reaching the substrate surface.

FIG. 4 is a plan view representation of plasma source 400 coupled to a process chamber lid 410, according to an illustrative embodiment of the invention. The plasma source includes a plurality of toroidal plasma chambers, 405a, 405b, . . . , 405n, generally 405, and a plurality of groups of circular magnetic cores, 410a, 410b, . . . , 410n, generally 410. Each of the plurality of toroidal plasma chambers 405 passes through a corresponding group of circular magnetic cores 410. For example, the toroidal plasma chamber 405a passes through the group of circular magnetic cores 410a, the toroidal plasma chamber 405b passes through the group of circular magnetic cores 410b, and the toroidal plasma chamber 405n passes through the group of circular magnetic cores 410n.

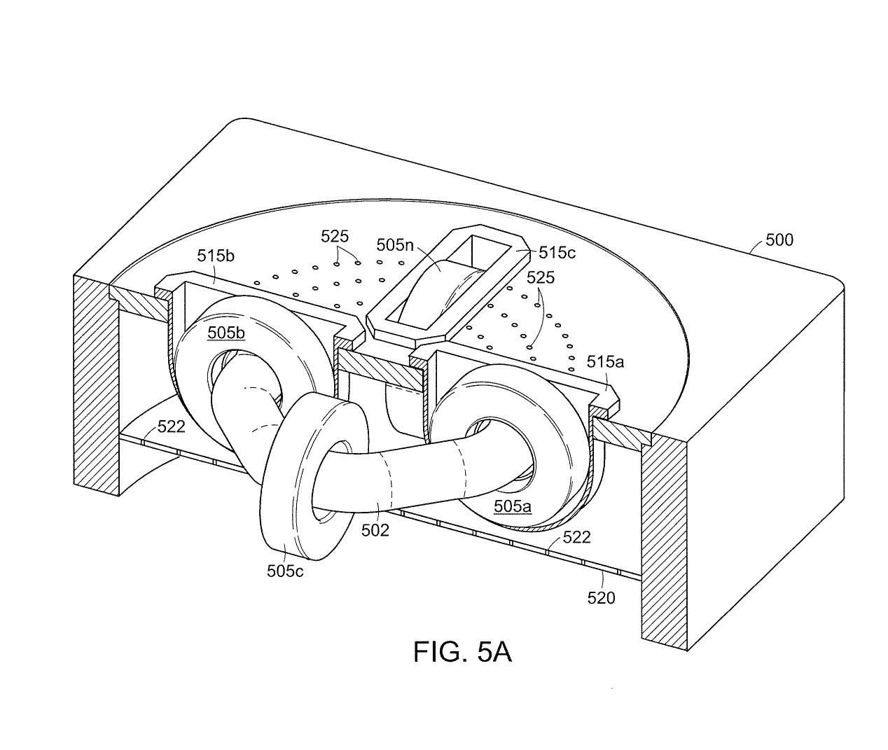

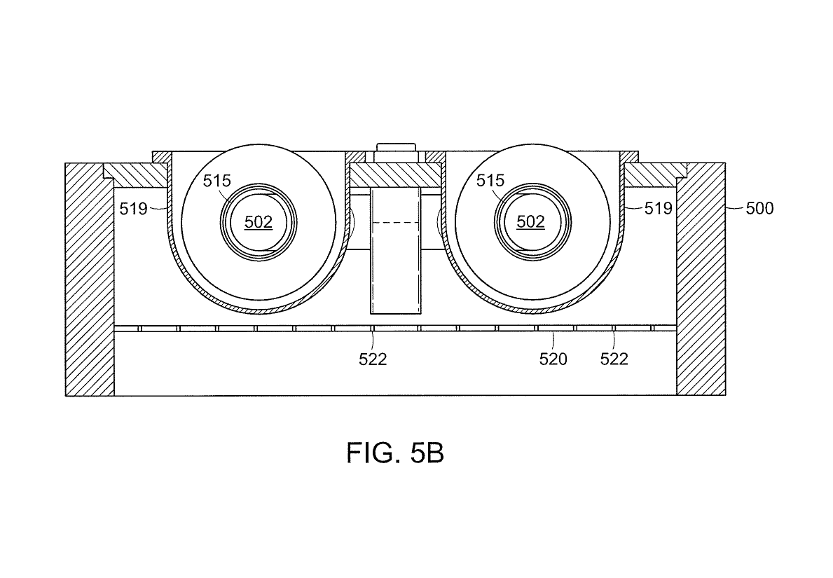

FIG. 5A is a three dimensional cross sectional view of a semiconductor processing chamber lid 500 that includes a plasma source, according to an illustrative embodiment of the invention. FIG. 5B is a two dimensional cross section view of the semiconductor process chamber lid 500 shown in FIG. 5A, according to an illustrative embodiment of the invention. In FIG. 5A and FIG. 5B, a plasma 502 is formed within the semiconductor process chamber (not shown) without being restricted by a plasma chamber. The semiconductor process chamber lid 500 includes a plurality of gas inlets 525 distributed in multiple concentric circles along the semiconductor processing chamber lid 500. In various embodiments, the plurality of gas inlets 525 is in any configuration known in the art.

A plurality of magnetic cores 505a, 505b, 505c, . . . 505n, generally 505, are positioned within the semiconductor processing chamber lid 500 so that when a plasma 502 is flowing within the semiconductor process chamber, the plasma current passes through the plurality of magnetic cores 505, flowing in a loop (e.g., circle or oval) within a first plane that is substantially parallel to a second plane that extends from a top surface of a sample holder within a semiconductor process chamber (e.g., sample holder 23 as shown above in FIG. 1). The process gases, flow substantially perpendicular to the second plane, flowing from the gas inlets of the plasma chamber towards the outlets of the plasma chamber such that the process gases are excited by the plasma.

As described above, the plurality of magnetic cores 505 provide power to the plasma and can be energized by a primary coil (not shown). The primary coil can be coupled to the plurality of magnetic cores 505 in the same manner as described above in FIG. 1A, FIG. 1B, and/or FIG. 1C. In some embodiments, the primary coil is integrated into a top portion 507 of the semiconductor process chamber lid 500. In some embodiments, the primary coil is driven by a RF switching power supply (not shown), for example, as described above with respect to FIG. 1.

A shielding structure surrounds each of the plurality of magnetic cores 505. The shielding structure ensures that the plasma 502 does not physically contact the plurality of magnetic cores 505. FIG. 5A and FIG. 5B include a partial view of the shielding structures, 515a, 515b, and 515c, generally 515.

In various embodiments, the shielding structure 515 is formed from a metal, a coated metal, and/or a dielectric. In some embodiments, the shielding structure 515 includes imbedded cooling channels to, for example, pass a fluid that controls the temperature of shielding structure 515. When a metallic material is used to form the shielding structure, the shielding structure 515 can be made of two halves with dielectric gaps in between each half, such that an induced electric current can be prevented from flowing along the shielding structure. The dielectric gap can include a dielectric spacer and a vacuum seal, and contain features for protecting the vacuum seal from damage by the plasma and/or UV radiation from the plasma.

In some embodiments, the shielding structures include an inner seal 517 and an outer seal 519. In some embodiments, only the inner seal 517 is a dielectric gap and the outer seal 519 is a vacuum seal that does not provide electric isolation to the outer seal. In various embodiments, the shielding structures are any structures known in the art to provide a seal between the plurality of magnetic cores 505 and the plasma 502.

The process chamber lid 500 can include a shower head member 520. The shower head member 520 includes a distribution of holes 522 to assist in an even distribution of gases activated by the plasma around a substrate being processed within the semiconductor process chamber.

In some embodiments, a grating is positioned a distance below the plasma 502 to distribute the activated gases within the semiconductor process chamber. In some embodiments, the semiconductor processing chamber lid 500 is metallic. For example, the semiconductor processing chamber lid 500 can be aluminum, copper, nickel and/or steel.

While the invention has been particularly shown and described with reference to specific embodiments, it should be understood by those skilled in the art that various changes in form and detail may be made therein without departing from the spirit and scope of the invention as defined by the appended claims.

What is claimed is:

1. A plasma source for providing dissociated gas to semiconductor process chamber, the plasma source comprising:
a plasma chamber having at least one gas inlet, at least one chamber wall for containing the gas, and at least one outlet into the semiconductor process chamber;
a plurality of magnetic cores disposed relative to the plasma chamber such that the plasma chamber passes through each of the plurality of magnetic cores,
the plasma chamber generating a toroidal plasma along a plane extending through the plasma chamber and which is at least substantially parallel to a top surface of a sample holder disposed within the semiconductor process chamber; and
a primary winding coupled to the plurality of magnetic cores.

2. The plasma source of claim 1 further comprising an RF power supply, the RF power supply having an output coupled to the primary winding to drive current in the primary winding, the current induces an AC potential within the plasma chamber.

3. The plasma source of claim 1 further comprising a showerhead located between the plasma chamber and the sample holder to distribute excited gas output from the plasma chamber over a substrate positioned atop the sample holder.

4. The plasma chamber of claim 1 further comprising at least one electrode capacitively coupled to the plasma chamber to generate free charges that assist the ignition of a plasma in the plasma chamber.

5. A method for dissociating gas within a plasma source for use in a semiconductor process chamber, the method comprising:
flowing via at least one inlet, a gas into a toroidal plasma chamber having a primary winding coupled to the toroidal plasma chamber and a plurality of magnetic cores oriented such that the toroidal plasma chamber passes through each of the plurality of magnetic cores;
generating a plasma along a plane extending through the toroidal plasma chamber, such plasma being at least substantially parallel to a top surface of a sample holder disposed within the semiconductor process chamber; and
directing the plasma, via at least one outlet in the toroidal plasma chamber, in an orthogonal direction relative to the plane toward the top surface of the sample holder.

6. The method of claim 5, further comprising coupling the toroidal plasma chamber to a top of the semiconductor process chamber.

7. The method of claim 6, further comprising positioning the at least one outlet in a substantially central location in the process chamber top.

8. The method of claim 6, further comprising evenly distributing the plurality of magnetic cores around a circumference of the toroidal plasma chamber.

9. The method of claim 1 further comprising positioning a showerhead between the plasma source and the sample holder to distribute excited gas output from the plasma chamber over a substrate positioned atop the sample holder.

10. The method of claim 6, further comprising:
flowing via a second gas inlet, the gas into a second toroidal plasma chamber having a second primary winding coupled to the second toroidal plasma chamber and a second plurality of magnetic cores oriented such that the second toroidal plasma chamber passes through each of the second plurality of magnetic cores;
generating a second plasma along a plane extending through the second toroidal plasma chamber, such second plasma being at least substantially parallel to a surface of the sample holder disposed within the semiconductor process chamber; and
directing the second plasma, via a second outlet in the toroidal plasma chamber, in a direction orthogonal to the plane toward the surface of the sample holder.

11. A plasma source comprising:
a toroidal plasma chamber;
a primary winding around an exterior of the toroidal plasma chamber; and
a plurality of magnetic cores, wherein the ring plasma chamber passes through each of the plurality of magnetic cores.

12. The toroidal plasma chamber of claim 11, wherein the toroidal plasma chamber is coupled to a process chamber top and further comprising a plurality of outlets into the process chamber top.

13. The toroidal plasma chamber of claim 12, wherein at least one of the plurality of outlets is located in a substantially central location in the process chamber top.

14. The toroidal plasma chamber of claim 11, further comprising at least one process gas inlet coupling a process gas source to the plasma chamber.

15. The toroidal plasma chamber of claim 11, wherein the magnetic cores are substantially evenly distributed around the circumference of the toroidal plasma chamber.

16. The plasma chamber of claim 11, wherein the ferrites are in a plurality of groups around the circumference of the toroidal plasma chamber.

17. The plasma source of claim 11, wherein the toroidal plasma chamber is coupled to a process chamber such that a toriodal plasma generated in the toroidal plasma chamber is at least substantially parallel to a top surface of a sample holder disposed within the process chamber.

18. A plasma source comprising:
a plurality of toroidal plasma chambers;
a plurality of primary windings, wherein each one of the plurality of primary windings is wrapped around an exterior one of the plurality of the toroidal plasma chambers; and
a plurality of magnetic cores, wherein each one of the plurality of the toroidal plasma chamber passes through a respective portion of the plurality of magnetic cores.

19. The plasma source of claim 18, wherein the plurality of toroidal plasma chambers are substantially concentric.

20. The plasma source of claim 18, wherein each one of the plurality of toroidal plasma chambers are adjacent to at least another one of the plurality of toroidal plasma chambers.

21. The plasma source of claim 18, wherein each one of the plurality of plasma chambers includes corresponding plurality of plasma chamber outlets coupling each one of the plurality the plasma chambers to a process chamber.

22. The plasma source of claim 18, further comprising at least one process gas inlet to couple a process gas source to each one of the plurality the plasma chambers.

23. The plasma source of claim 18, wherein the magnetic cores are substantially evenly distributed around the circumference of the ring plasma chamber.

24. The plasma source of claim 18, wherein the magnetic cores are in a plurality of groups each group is located around the circumference of one of the plurality of ring plasma chambers.

25. The plasma source of claim 18, wherein the toroidal plasma chamber is one of a group of shapes consisting of substantially round, substantially triangular, substantially rectangular, or substantially polygonal shape.

26. The plasma source of claim 18, wherein each of the plurality of toroidal plasma chambers is coupled to a process chamber such that a plasma generated in each of the plurality of toroidal plasma chambers is substantially parallel to a substrate within the process chamber.

27. A plasma source comprising:
a toroidal plasma chamber;
a primary winding around an exterior of the toroidal plasma chamber;
a plurality of magnetic cores, wherein the toroidal plasma chamber passes through each of the plurality of magnetic cores; and
a plurality of plasma chamber outlets coupling the toroidal plasma chamber to a process chamber, each one of the plurality plasma chamber outlets having a respective plasma restriction.

28. The plasma source of claim 27, further comprising at least one process gas inlet coupling a process gas source to the plasma chamber.

29. The plasma source of claim 28, further comprising a process gas flow rate control device coupled to the at least one process gas inlet.

30. The plasma source of claim 27, wherein the magnetic cores are substantially evenly distributed around the circumference of the ring plasma chamber.

31. The plasma source of claim 27, wherein the magnetic cores are in a plurality of groups, each group is located around the circumference of the toroidal plasma chamber.

32. The plasma source of claim 27, wherein the toroidal plasma chamber is one of a group of shapes consisting of substantially round, substantially triangular, substantially rectangular, or substantially polygonal shape.

33. The plasma source of claim 27, wherein the toroidal plasma chamber is coupled to a process chamber such that a plasma generated in the toroidal plasma chamber is substantially parallel to a substrate within the process chamber.
